(19) United States
(12) Patent Application Publication
(10) Pub. No.: US 2023/0381945 A1
(43) Pub. Date: Nov. 30, 2023

(54) TOOL BOX

(71) Applicant: Sheng-Feng TSAI, Taichung City (TW)

(72) Inventor: Sheng-Feng TSAI, Taichung City (TW)

(21) Appl. No.: 17/752,627

(22) Filed: May 24, 2022

(51) Int. Cl. B25H 3/02; B65D 25/04

(52) U.S. Cl. CPC B25H 3/023; B65D 25/04

(57) ABSTRACT

A tool box is provided, including: a main body, including an intermediate member and two shell members, the intermediate member including a first connection portion and a second connection portion, the first connection portion and the second connection portion being arranged in a first direction, one of the two shell members being rotatably connected to the first connection portion, the other of the two shell members being rotatably connected to the second connection portion so that the two shell members are capable of covering two sides of the intermediate member in the first direction; a buckle member, movably disposed on the main body and configured to restrict the two shell members from rotating relative to the intermediate member.

### BACKGROUND OF THE INVENTION

### Field of the Invention

The present invention relates to a tool box.

### Description of the Prior Art

A tool box is a container for placing articles such as locks, hand tools or the like, which is convenient to carry and prevents the articles in the tool box from being damaged. The conventional tool box is generally composed of two shell members rotatably connected to each other, which is easy to open or close.

However, since the conventional tool box is composed of only two shell members, it is so limited to the storage capacity. To increase the storage capacity, the thickness of the two shell members must be much increased, which greatly increases the manufacturing cost and the weight of the tool box. Moreover, the shell member is hard to open because the shell member is heavy, which is uneasy to operate.

The present invention is, therefore, arisen to obviate or at least mitigate the above-mentioned disadvantages.

### SUMMARY OF THE INVENTION

The main object of the present invention is to provide a tool box which can increase the capacity for storing articles without increasing thicknesses, weight and cost, and is easy to operate.

To achieve the above and other objects, a tool box is provided, including: a main body, including an intermediate member and two shell members, the intermediate member including a first connection portion and a second connection portion, the first connection portion and the second connection portion being arranged in a first direction, one of the two shell members being rotatably connected to the first connection portion, the other of the two shell members being rotatably connected to the second connection portion so that the two shell members are capable of covering two sides of the intermediate member in the first direction; a buckle member, movably disposed on the main body and configured to restrict the two shell members from rotating relative to the intermediate member.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a breakdown drawing of a preferable embodiment of the present invention;

FIG. 3 is a drawing showing a partition of another preferable embodiment of the present invention;

FIG. 4 is another breakdown drawing of a preferable embodiment of the present invention;

FIGS. 5 and 6 are drawings showing operation of a preferable embodiment of the present invention;

FIG. 7 is a cross-sectional view, taken along a line A-A, of FIG. 1;

FIG. 8 is a cross-sectional view, taken along a line B-B, of FIG. 1;

FIG. 9 is another stereogram of a preferable embodiment of the present invention; and

FIG. 10 is a drawing showing a plurality of tool boxes stacked according to a preferable embodiment of the present invention.

### DETAILED DESCRIPTION OF THE PREFERRED EMBODIMENTS

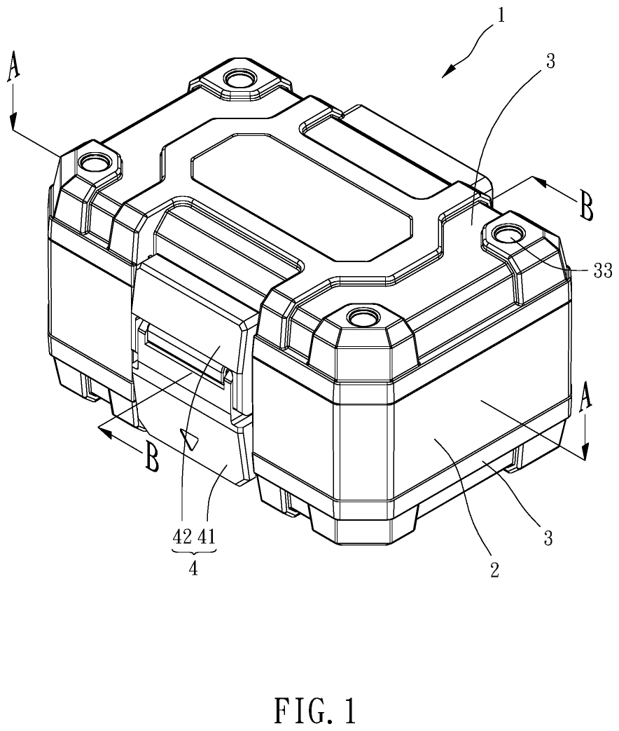

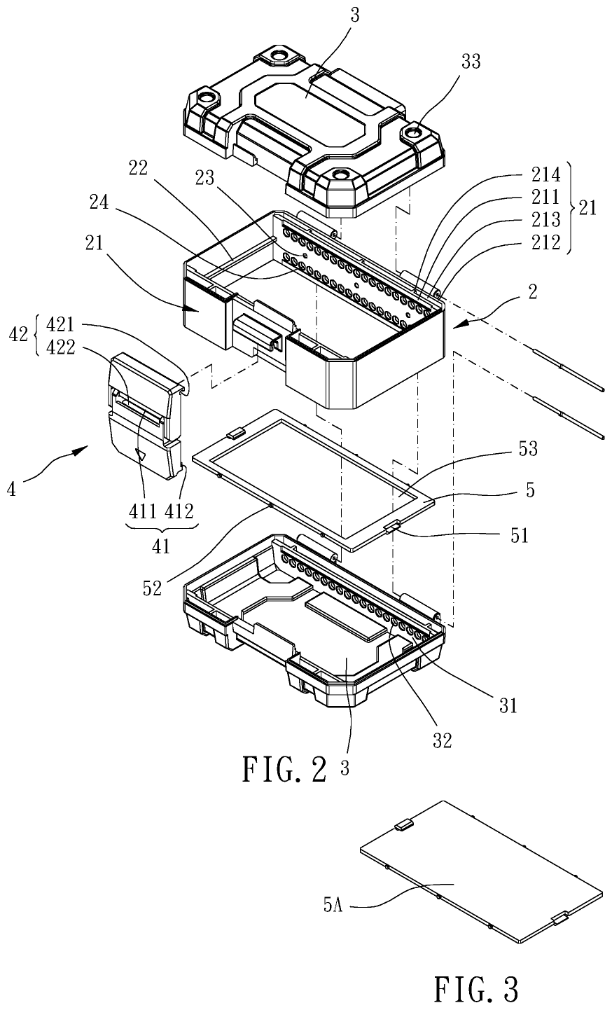

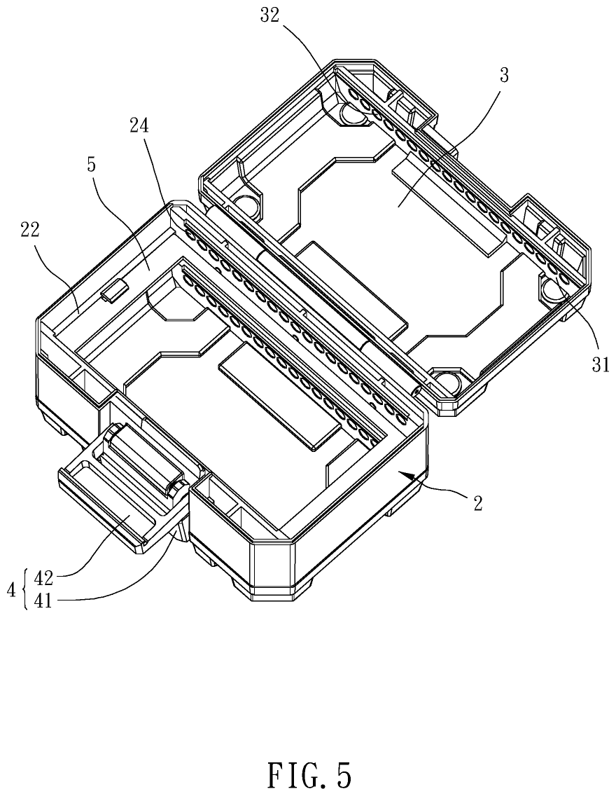

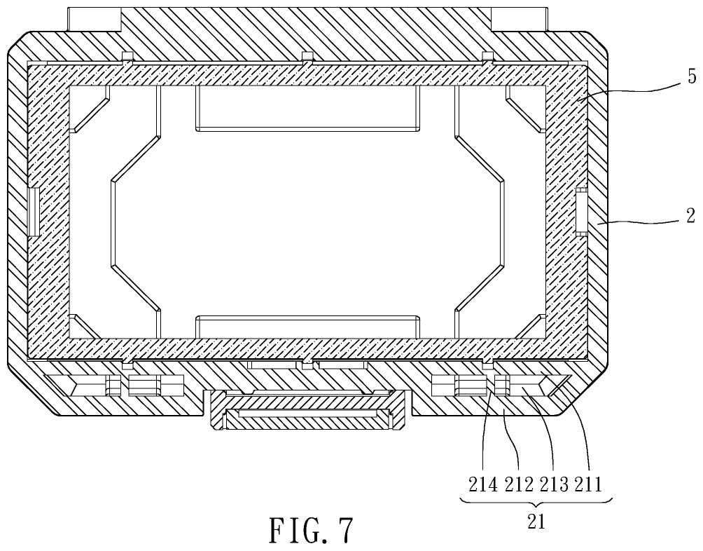

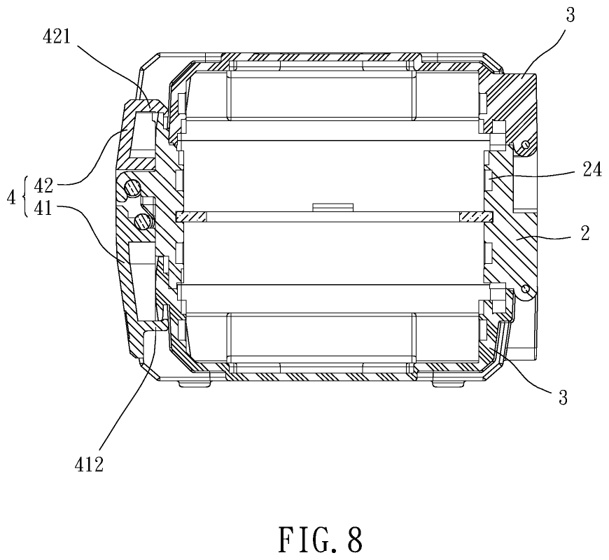

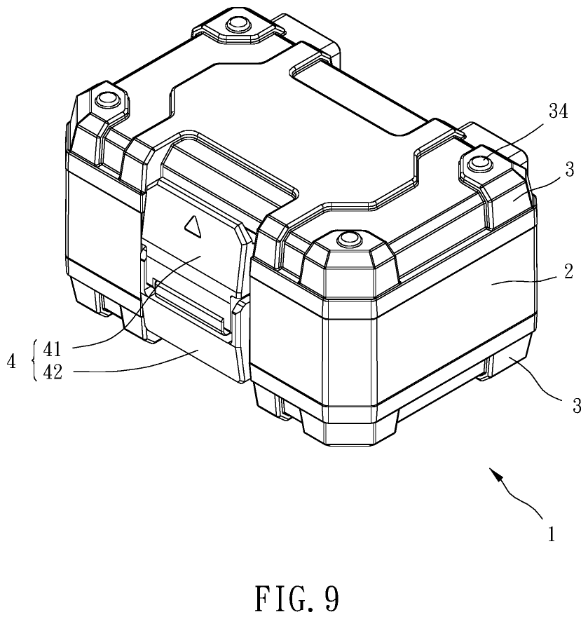

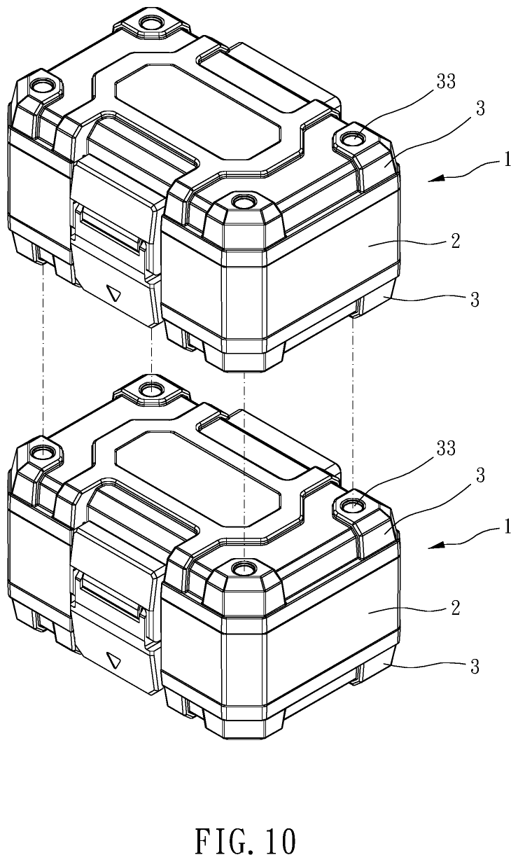

Please refer to FIGS. 1 to 10 for a preferable embodiment of the present invention. A tool box of the present invention includes a main body 1 and a buckle member 4.

The main body 1 includes an intermediate member 2 and two shell members 3, the intermediate member 2 includes a first connection portion 11 and a second connection portion 12, and the first connection portion 11 and the second connection portion 12 are arranged in a first direction. One of the two shell members 3 is rotatably connected to the first connection portion 11, and the other of the two shell members 3 is rotatably connected to the second connection portion 12, so that the two shell members 3 are capable of covering two sides of the intermediate member 2 in the first direction.

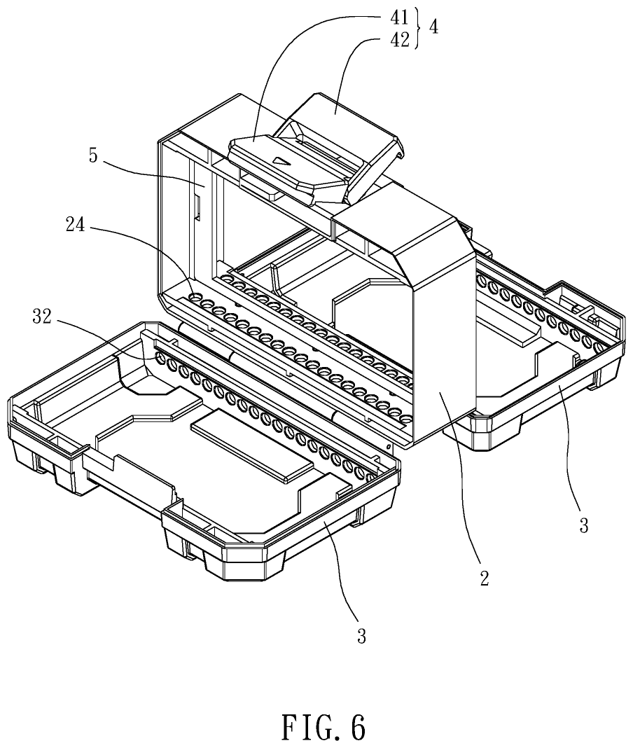

The buckle member 4 is movably disposed on the main body 1 and configured to restrict the two shell members 3 from rotating relative to the intermediate member 2.

Whereby, the intermediate member 2 can increase the capacity of the main body 1 for storing articles without increasing thicknesses of the two shell members 3, so the tool box is of light weight and low production cost. Since the two shell members 3 are rotatably connected to the first connection portion 11 and the second connection portion 12, respectively, so that the two shell members 3 do not interfere with each other during rotation. Preferably, the first connection portion 11 and the second connection portion 12 are disposed at opposing ends of the intermediate member 2 in the first direction, which provides large range for rotation of the two shell members 3 (FIGS. 5 and 6).

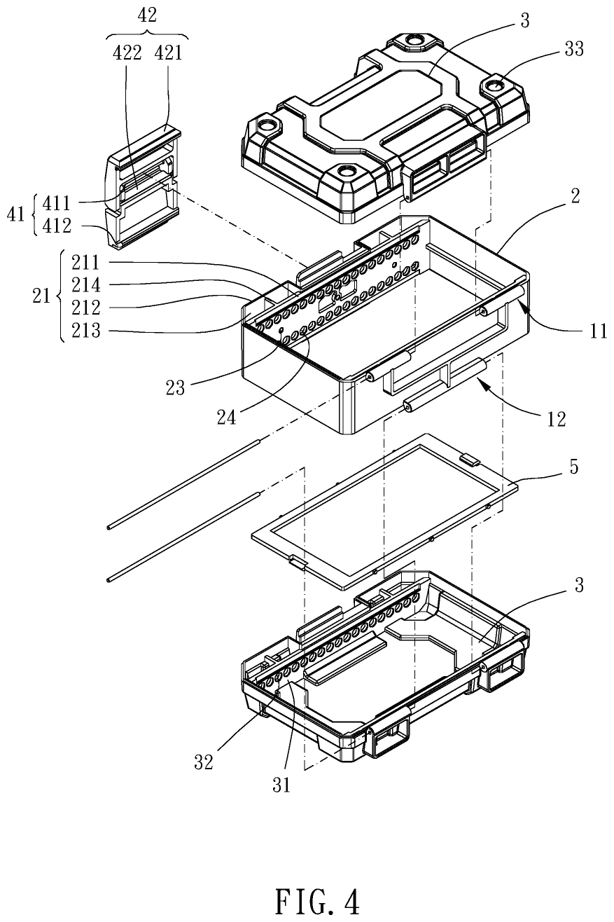

Specifically, the intermediate member 2 includes a plurality of first side walls 21, the plurality of first side walls 21 are connected to be annular, the tool box further includes a partition 5, the partition 5 is detachably disposed in the intermediate member 2, the plurality of first side walls 21 surrounds the intermediate member 2, and the partition 5 partitions an interior of the main body 1 into two regions for storing different articles. In this embodiment, the partition 5 includes a through hole 53 communicating the two regions. However, the partition 5A may be provided without any through hole (FIG. 3).

Specifically, two sides of the partition 5 each include an engaging slot 51, two opposing ones of the plurality of first side walls 21 each include an engaging projection 22, and the engaging projection 22 is engaged in the engaging slot 51 so that the partition 5 is positioned to the intermediate member 2. Another two sides of the partition 5 each include at least one or a plurality of protrusions 52, and another two opposing ones of the plurality of first side walls 21 each include at least one or a plurality of first insertion holes 23 in which the protrusions are inserted so that the partition 5 is firmly secured to the intermediate member 2.

Preferably, two opposing ones of the plurality of first side walls 21 each include a plurality of second insertion holes 24 located adjacent to two ends of the intermediate member 2 and arranged along a direction transverse to the first direction, wherein the second insertion holes 24 are configured to receiving articles. Preferably, the shell member 3 includes a plurality of second side walls 31, and two opposing ones of the plurality of second side walls 31 each include a plurality of third insertion holes 32 arranged along a direction transverse to the first direction, wherein the second insertion holes 24 are configured to receiving articles.

Two of the plurality of first side walls 21 each include an inner layer 211 and an outer layer 212 which form a gap 213 which is advantageous in demolding. A rib 214 is connected to and between the inner layer 211 and the outer layer 212, which enhances the structural strength of the inner layer 211 and the outer layer 212. The plurality of second insertion holes 24 are disposed on the inner layer 211.

Specifically, the buckle member 4 includes a first member 41 and a second member 42, the first member 41 includes a first connection end 411 and a first buckling end 412, and the second member 42 includes a second connection end 422 and a second buckling end 421. The first connection end 411 is rotatably connected to a side of the intermediate member 2 opposite to the first connection portion 11, and the second connection end 422 is rotatably connected to a portion of the first member between the first connection end and the first buckling end. When the two shell members 3 cover the intermediate member 2, the first buckling end 412 and the second buckling end 421 buckle the two shell members 3, respectively. In use, it is to rotate the first member 41 and the second member 42 to make the first buckling end 412 and the second buckling end 421 buckled to the two shell members 3, respectively, for locking the two shell members 3.

A side of one of the two shell members 3 remote from the intermediate member 2 includes a plurality of concave portions 33, and a side of the other of the two shell members 3 remote from the intermediate member 2 includes a plurality of convex portions 34 corresponding to the plurality of concave portions 33 in shape. The plurality of concave portions 33 may receive the plurality of concave portions 33 of another main body 1, for stacking of a plurality of tool boxes.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A tool box, including:
a main body, including an intermediate member and two shell members, the intermediate member including a first connection portion and a second connection portion, the first connection portion and the second connection portion being arranged in a first direction, one of the two shell members being rotatably connected to the first connection portion, the other of the two shell members being rotatably connected to the second connection portion so that the two shell members are capable of covering two sides of the intermediate member in the first direction;
a buckle member, movably disposed on the main body and configured to restrict the two shell members from rotating relative to the intermediate member.

2. The tool box of claim 1, wherein the intermediate member includes a plurality of first side walls, the plurality of first side walls are connected to be annular, the tool box further includes a partition, the partition is detachably disposed in the intermediate member, the plurality of first side walls surrounds the intermediate member, and the partition partitions an interior of the main body.

3. The tool box of claim 2, wherein two sides of the partition each include an engaging slot, two opposing ones of the plurality of first side walls each include an engaging projection, and the engaging projection is engaged in the engaging slot.

4. The tool box of claim 3, wherein another two sides of the partition each include at least one protrusion, and another two opposing ones of the plurality of first side walls each include at least one first insertion hole in which the protrusion is inserted.

5. The tool box of claim 2, wherein two opposing ones of the plurality of first side walls each include a plurality of second insertion holes located adjacent to two ends of the intermediate member and arranged along a direction transverse to the first direction.

6. The tool box of claim 5, wherein two of the plurality of first side walls each include an inner layer and an outer layer which form a gap therebetween, a rib is connected to and between the inner layer and the outer layer, and the plurality of second insertion holes are disposed on the inner layer.

7. The tool box of claim 1, wherein the shell member includes a plurality of second side walls, and two opposing ones of the plurality of second side walls each include a plurality of third insertion holes arranged along a direction transverse to the first direction.

8. The tool box of claim 1, wherein the buckle member includes a first member and a second member, the first member includes a first connection end and a first buckling end, the second member includes a second connection end and a second buckling end, the first connection end is rotatably connected to a side of the intermediate member opposite to the first connection portion, the second connection end is rotatably connected to a portion of the first member between the first connection end and the first buckling end, and when the two shell members cover the intermediate member, the first buckling end and the second buckling end buckle the two shell members, respectively.

9. The tool box of claim 1, wherein the first connection portion and the second connection portion are disposed at two ends of the intermediate member in the first direction.

10. The tool box of claim 6, wherein two sides of the partition each include an engaging slot, two opposing ones of the plurality of first side walls each include an engaging projection, and the engaging projection is engaged in the engaging slot; another two sides of the partition each include at least one protrusion, and another two opposing ones of the plurality of first side walls each include at least one first insertion hole in which the protrusion is inserted; the shell member includes a plurality of second side walls, two opposing ones of the plurality of second side walls each include a plurality of third insertion holes arranged along a direction transverse to the first direction; the buckle member includes a first member and a second member, the first member includes a first connection end and a first buckling end, the second member includes a second connection end and a second buckling end, the first connection end is rotatably connected to a side of the intermediate member opposite to the first connection portion, the second connection end is rotatably connected to a portion of the first member between the first connection end and the first buckling end, and when the two shell members cover the intermediate member, the first buckling end and the second buckling end buckle the two shell members, respectively; a side of one of the two shell members remote from the intermediate member includes a plurality of concave portions, and a side of the other of the two shell members remote from the intermediate member includes a plurality of convex portions corresponding to the plurality of concave portions in shape.
